(19) United States
(12) Patent Application Publication
(10) Pub. No.: US 2019/0054474 A1
(43) Pub. Date: Feb. 21, 2019

(54) COMMINUTION MACHINE

(71) Applicant: UNTHA shredding technology GmbH, Kuchl (AT)

(72) Inventors: Stefan PISCHON, Kuchl (AT); Andreas REST, Kuchl (AT)

(21) Appl. No.: 16/169,030

(22) Filed: Oct. 24, 2018

Related U.S. Application Data
(63) Continuation of application No. PCT/AT2017/060088, filed on Apr. 7, 2017.

(30) Foreign Application Priority Data
Apr. 29, 2016 (EP) 16167740.6

(51) Int. Cl. B02C 13/282; B02C 18/22

(52) U.S. Cl. CPC B02C 13/282; B02C 2018/162; B02C 18/2216; B02C 18/2241

(57) ABSTRACT

A comminuting machine for comminuting material includes a machine frame, a comminuting rotor rotatably mounted on the machine frame, and a material feed area. The material feed area has a wall section over which the material to be comminuted can be supplied to the comminuting rotor and which is designed to be stationary during a comminuting operation of the comminuting machine and can be pivoted about a rotational axis during a maintenance operation of the comminuting machine. Because the rotational axis is designed to be releasably lockable, a second releasably lockable rotational axis is provided together with the first rotational axis, and the wall section of the material feed area can selectively be pivoted about the first or second rotational axis during the maintenance operation of the comminuting machine.

### BACKGROUND OF THE INVENTION

The invention concerns a comminuting machine for comminuting material, in particular recyclable materials, scrap wood and data carriers, including a machine frame, at least one comminuting rotor mounted rotatably to the machine frame and a material delivery space, wherein the material delivery space has at least one wall portion, by way of which the material to be comminuted can be fed to the at least one comminuting rotor, and which is stationary in a comminuting mode of operation of the comminuting machine and is pivotable about an axis of rotation in a maintenance mode of operation of the comminuting machine.

Such comminuting machines are known from the state of the art, for example EP 2 218 508 A1.

FIG. 1 shows a relevant portion of such a comminuting apparatus 101 as a sectional view: the comminuting machine 101 includes a machine frame 104 to which a comminuting rotor 105 is rotatably mounted. The material to be comminuted by means of the comminuting rotor 105 is fed to the comminuting machine 101 by way of a material delivery space 106, wherein the material delivery space 106 can be loaded manually for example by wheel loaders, fork lift trucks or conveyor belts. The comminuting machine 101 further includes a feed device 120 which is mounted pivotably to the machine frame 104 and with which the material to be comminuted can be conveyed to the comminuting rotor 105. In this case the feed device 120 includes a pivot arm and a pressing member 121 arranged at the free end of the pivot arm 122. The pressing member 121 has a pressing surface 133 and an underside 138. The feed device 120 is guided along a pressing wall 126 in the comminuting mode of operation. In the lower region the pressing wall 126 includes a wall portion 107 which for maintenance purposes is pivotable about an axis of rotation 108 by means of a piston-cylinder unit 128. In that case the wall portion 107 is pivoted into the material delivery space 106. In that way an operator 134 gains access to the comminuting rotor 105 and can for example change comminuting blades arranged on the rotor 105.

A further typical maintenance operation involves cleaning the interior of the machine. That is only region-wise possible in the comminuting machine 101 shown in FIG. 1 by a pivotal movement of the wall portion 107. In particular extensive cleaning in the region of the feed device 120 requires laborious dismantling of individual components like for example hydraulic cylinders which move the feed device 120, or the piston-cylinder unit 128 which moves the wall portion 107.

A further disadvantage of the state of the art shown in FIG. 1 is that, in the event of jamming of the feed device 120, in the region of the wall element 107, that wall element 107 cannot be opened to remove the jam. Such blocking of the feed device can only be overcome by laborious dismantling of parts or the entire unit.

And finally there is the disadvantage that upon a change from one kind of material to be comminuted to another differing kind of material to be comminuted, the removal that is required in that situation of the residual material remaining in the material delivery space is possible only with a closed wall portion 107 and by climbing into the material delivery space 106 from the front or above as a large part of the residual material comes to lie above the wall portion 107 when the wall portion 107 is opened and is thus not accessible to the machine operator in the illustrated position.

EP 2 857 101 A1 describes a solution in which the attempt is made to overcome some of the described disadvantages, by the wall portion being mounted pivotably about an axis of rotation which is displaced from the end. Upon a pivotal movement about that axis of rotation, an upper opening which permits access to the feed device and a lower opening which permits access to the rotor are opened at the same time.

A disadvantage with that solution however is still the fact that, in the event of jamming of the feed device in the region of the axis of rotation, the maintenance flap cannot be opened at all in many cases. In that case the feed device has to be dismantled as before in order to be able to remove the jam.

A further disadvantage of the solution disclosed in EP 2 857 101 A1 is that the access to the upper opening, that is to say the access to the feed device, is only possible in a highly complicated procedure: For that purpose an operator has to climb on to a platform or a ladder and bridge across the portion of the maintenance flap that projects towards him. The room for manoeuvre on the part of the operator is severely limited thereby.

### SUMMARY OF THE INVENTION

Therefore the technical object of the present invention is to provide a comminuting machine in which the disadvantages of the state of the art are overcome and in which in particular quick and uncomplicated maintenance by an operator is possible.

According to the invention therefore it is provided that the axis of rotation is adapted to be releasably lockable, provided besides said first axis of rotation is at least one second releasably lockable axis of rotation and the at least one wall portion of the material delivery space in the maintenance mode of the comminuting machine is pivotable selectively about the first or the at least one second axis of rotation.

The fact that the at least one wall portion of the material delivery space in the maintenance mode of operation of the comminuting machine is pivotable selectively about the first or the at least one second axis of rotation means that different regions of the material delivery space can be made accessible for maintenance operations, more specifically even when the comminuting machine includes a feed device and same has become jammed in the region of the at least one wall portion. More specifically the selective pivotability about the first and the at least one second axis of rotation provides the prerequisite that the at least one wall portion is also moveable away from the material delivery space and thus the feed device. At the same time for maintenance purposes the feed device can be moved into any desired position without a maintenance flap which projects into the material delivery space being in the way.

Dismantling of levers, hydraulic cylinders or other machine components is no longer necessary for complete maintenance of the comminuting machine and to overcome typical operational troubles. Complete emptying of the material delivery space in order to be able to provide for single-origin processing of the material to be subsequently processed is possible without any problem without an operator having to move into an inconvenient position for that purpose.

### BRIEF DESCRIPTION OF THE DRAWINGS

Three particularly preferred embodiments are discussed hereinafter with reference to the Figures, in which:

FIG. 1 shows the comminuting machine described in the opening part of this specification in accordance with the state of the art,

FIGS. 2-4 are diagrammatic sectional views of a portion of a first embodiment of the invention,

FIG. 5 is a diagrammatic sectional view of a portion of a second embodiment of the invention,

FIGS. 6-8 are diagrammatic sectional views of a portion of a third embodiment of the invention, and

FIGS. 9a-9c are side view of a further portion of the comminuting machine according to one of the three embodiments to illustrate the comminuting mode of operation (FIG. 9a) and the maintenance mode of operation (FIGS. 9b and 9c) respectively.

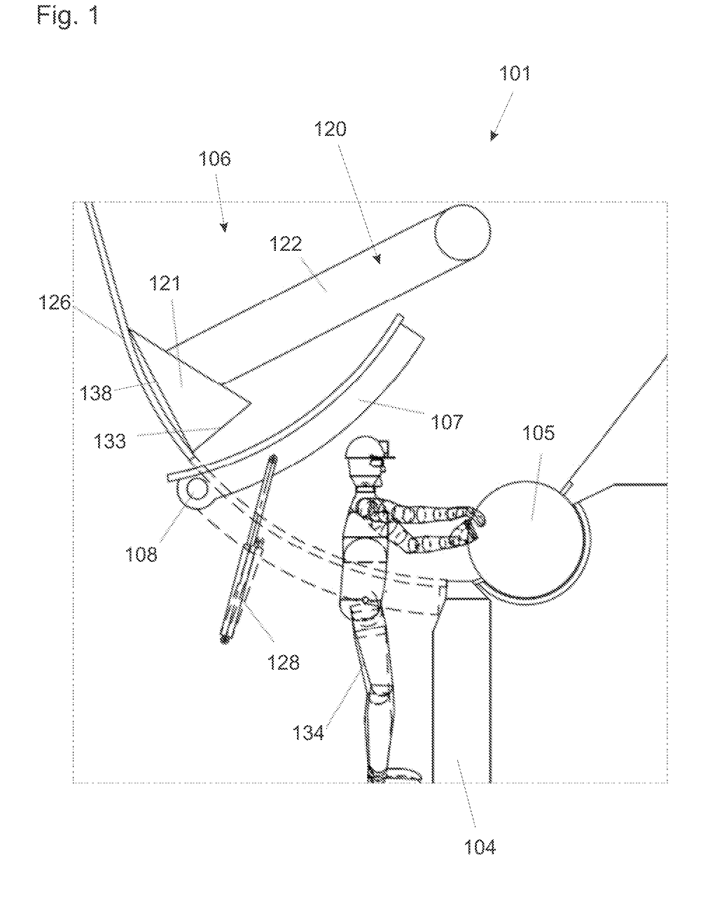

### DETAILED DESCRIPTION OF THE INVENTION

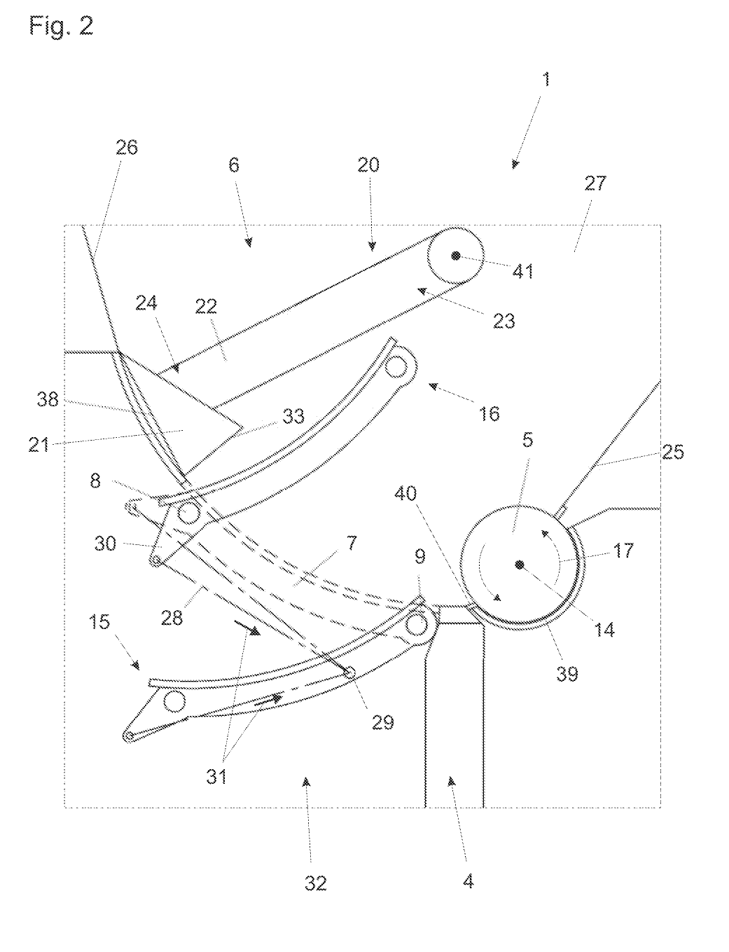

The comminuting machine 1 shown in FIGS. 2 to 4 serves for comminuting material, in particular recyclable materials, scrap wood and data carriers, in which respect the term data carriers is used to denote for example documents or written CDs.

The comminuting machine 1 includes a machine frame 4. A comminuting rotor 5 is mounted rotatably about an axis of rotation 14 to the machine frame 4. Instead of a comminuting rotor it is also possible to provide a plurality of comminuting rotors. Arranged on the comminuting rotor 5 are for example tearing hooks or blades which can be provided with a concavely ground cutter head. The blades can be fixed by screw means to blade carriers which in turn can be screwed or welded to or into blade pockets milled in the rotor. The rotating blades cooperate with stationary fixed counterpart blades for comminuting material. The counterpart blades can be in the form of stator blades or stripping combs. Preferably the counterpart blades 40 are fixedly connected to the machine frame 4. To bring about a relative movement between the blades arranged on the rotor 5 and the counterpart blades 40 the rotor 5 performs a rotational movement in a given direction of rotation 17. In the illustrated views the rotational movement is in the counter-clockwise direction. A drive means, for example in the form of a torque motor, is provided for rotation of the comminuting rotor 5.

The material comminuted between the rotating blades and the counterpart blades is subsequently discharged through a sieve device 39 which determines the comminuting factor in accordance with the sieve size and further conveyed for example by means of a conveyor belt, a conveyor screw, a chain conveyor or a suction removal installation.

The material to be comminuted passes to the comminuting rotor 5 by way of a material delivery space 6 which in the illustrated case is defined by a front wall 25, a rear wall 26 arranged on the other side of the comminuting rotor 5 and two side walls 27, wherein only one of those two side walls 27 is shown in FIGS. 2 to 8 by virtue of the view adopted. A filling hopper can also be fitted on to the material delivery space 6.

The comminuting machine 1 is shielded region-wise outwardly by a housing 32.

The comminuting machine 1 further includes a feed device 20 which is mounted pivotably to the machine frame 4 and with which the material to be comminuted can be conveyed to the comminuting rotor 5. In that case the pivotal movement of the feed device 20 is about an axis of rotation 41. This is oriented substantially parallel to the axis of rotation 14 of the comminuting rotor 5. The feed device 20 has a wedge-shaped pressing member 21 with a pressing surface 33 which faces towards the comminuting rotor 5 and which for example can be of a substantially flat or concavely curved configuration. Material which is between the pressing surface 33 and the comminuting rotor 5 is pushed in the direction of the comminuting rotor 5 by a pivotal movement of the feed device 20. The pressing member 21 further has an underside 38 which is towards the rear wall 26 of the material delivery space 6. The feed device 20 further has at least one and preferably two mutually spaced pivot arms 22, wherein the pivot arms 22 each include a first end 23 and a second end 24 and wherein the feed device 20 is mounted to the machine frame 4 by way of the first end 23 and the pressing member 21 is arranged at the second free end 24. In an advantageous configuration of the feed device 20 the two pivot arms 22 which are arranged parallel to each other and the pressing member 21 disposed thereon substantially form a U-shape.

The drive for the feed device 20 is by way of a drivable shaft, wherein the drivable shaft can be connected to a lever mechanism as part of a drive arrangement disposed outside the material delivery space 6. Such an arrangement for the lever mechanism outside the material delivery space 6 has the advantage that the lever mechanism is not adversely affected by the material to be comminuted. Otherwise it would be conceivable that a linkage included in the lever mechanism could be disturbed or indeed partly blocked if it were installed within the material delivery space 6. A hydraulic cylinder or a pneumatic cylinder can be connected to the lever mechanism and adapted to drive the lever mechanism. Such cylinders represent reliable, relatively inexpensive drive means which are easy to replace or which are interchangeable. Alternatively it is possible to provide at least one motorized drive, for example an adjusting motor or a torque motor for driving the shaft.

The comminuting machine 1 further includes a wall portion 7 which is designed to be stationary in the comminuting mode of operation of the comminuting machine 1 and by way of which the material to be comminuted can be fed to the comminuting rotor 5. In the maintenance mode of the comminuting machine 1 the wall portion 7 is pivotable selectively about a first releasably lockable axis of rotation 8 or a second releasably lockable axis of rotation 9.

FIG. 2 shows in broken line the position of the wall portion 7 in the comminuting mode. In this case both axes of rotation 8 and 9 are locked. In the comminuting mode the pressing member 21 of the feed device 20 moves along the wall portion 7 towards or away from the comminuting rotor 5.

To carry out maintenance operations or to eliminate operational troubles like for example jamming of material between the feed device 20 and the wall portion 7 the comminuting machine 1 can be maintained in a maintenance mode. For that purpose the wall portion 7 can be pivoted either about the first axis of rotation 8 or about the second axis of rotation 9. In that case the axis of rotation 8 or 9 about which the wall portion 7 is pivoted is locked and the other non-active axis of rotation 9 or 8 respectively is released at the same time.

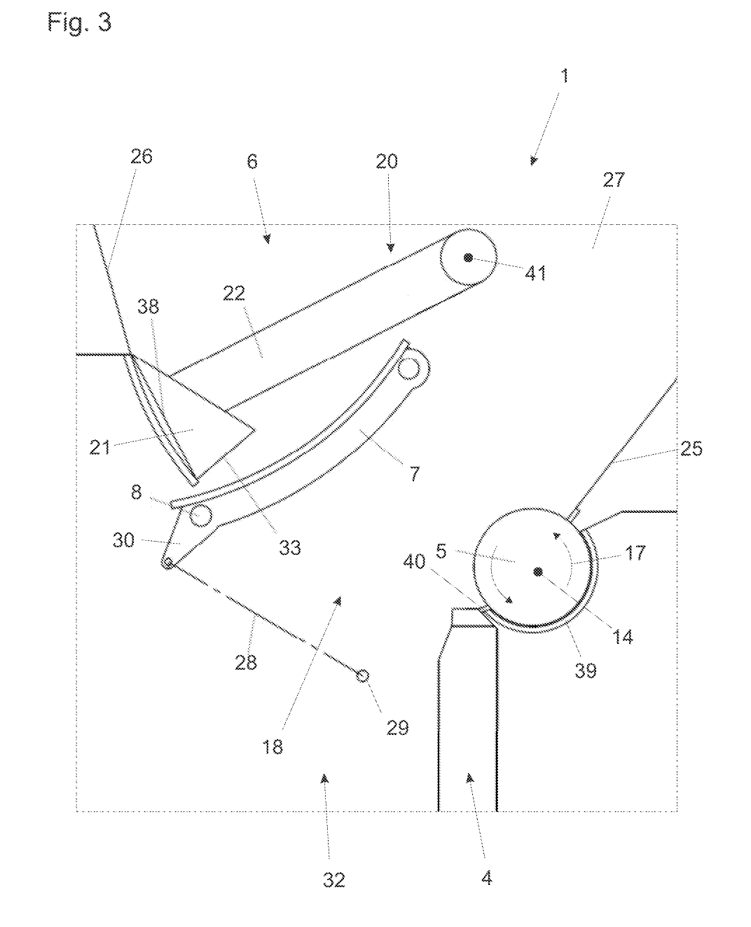

In a pivotal movement of the wall portion 7 about the first axis of rotation 8 the wall portion 7 is moved into the material delivery space 6, starting from the position in the comminuting mode. That provides a first opening 18 having access to the comminuting rotor 5. The end position after that pivotal movement is shown separately in FIG. 3. In that position of the wall portion 7 an operator can pass without any problem from below region-wise into the material delivery space 6 and access the comminuting rotor 5. In that way the operator can carry out maintenance operations on the comminuting rotor 5 and manually remove residual material in that region of the material delivery space 6, for example before a change in material.

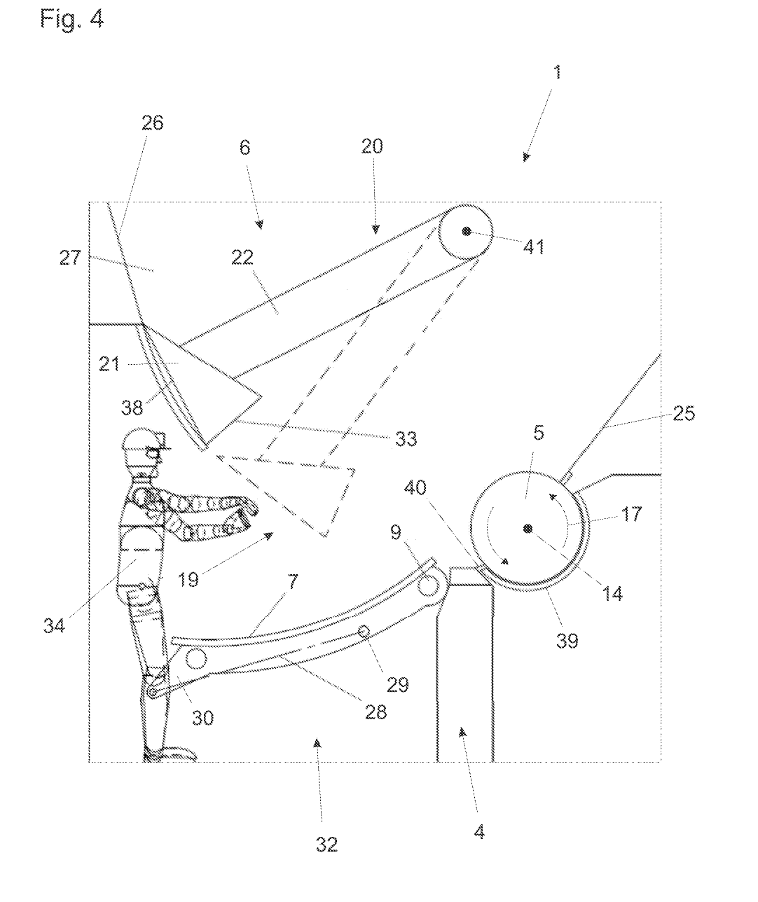

In a pivotal movement of the wall portion 7 about the second axis of rotation 9 the wall portion 7 is moved away from the material delivery space 6. The end position which the wall portion 7 assumes after that pivotal movement is shown separately in FIG. 4. In that pivotal position of the wall portion 7 an operator 34 enjoys free access to the feed device 20 and in particular to the pressing unit 21. In that case the feed device 20 can be moved into any position which is appropriate for carrying out the pending maintenance operation. Possible jamming of material between the pressing member 21 and the wall portion 7 can be easily dealt with by pivoting the wall portion 7 away about the second axis of rotation 9.

For moving the wall portion 7 from the position which the wall portion 7 assumes in the comminuting mode into the two pivotal positions shown in FIGS. 3 and 4 the machine has a displacement device 28, for example in the form of a hydraulic piston-cylinder unit, which is supported on the one hand on the machine frame 4 by way of a mounting location 29 and on the other hand is connected to the wall portion 7 by way of an engagement location 30.

In alternative embodiments the displacement device 28 can also be implemented by electrical adjusting units or lever mechanisms or combinations thereof.

In the case of a piston-cylinder unit it is appropriate for the cylinder to be arranged to engage the mounting location 29 and for the piston to be connected to the engagement location 30 of the wall portion 7. In the illustrated case the engagement location 30 is in the form of a lever portion which is angled with respect to the wall portion 7.

The displacement device 28 is advantageously arranged on the machine frame 4 in relation to the first and second axes of rotation 8 and 9 in such a way that the displacement device 28 has to perform a displacement movement directed in the same direction 31—with respect to the mounting location 29 to the machine frame 4—both to pivot the wall portion 7 about the first axis of rotation 8 and also to pivot the wall portion 7 about the second axis of rotation 9, in each case starting from the position in the comminuting mode. In the case of a piston-cylinder unit this involves a stroke movement of the cylinder which is respectively directed in the same direction.

In addition in all positions of the wall portion 7 upon a pivotal movement about the first or second axis of rotation 8 or 9 and in the mounted position of the comminuting machine 1 the displacement device 28 is arranged completely or for the predominant part below the respectively active axis of rotation 8 or 9. That configuration is advantageous for the reason that upon a pivotal movement of the wall portion 7 it can prevent material which falls out of the material delivery space 6 reaching the displacement device 28 and possibly damaging it. Rather the displacement device 28 is protected from dropped material by the wall portion 7.

It should also be pointed out that in the illustrated embodiment the two releasably lockable axes of rotation 8 and 9 are oriented substantially parallel to each other and substantially parallel to the axis of rotation 14 of the comminuting rotor 5, and the first axis of rotation 8 in the mounted position of the comminuting machine 1 is arranged above the second axis of rotation 9 and the first axis of rotation 8 is arranged at a first end 15 of the wall portion 7 and the second axis of rotation 9 is arranged at a second end 16 of the wall portion 7 and the second axis of rotation 9 is arranged immediately adjacent to the comminuting rotor 5. In comparison the first axis of rotation 8 is at a greater spacing relative to the comminuting rotor 5.

To move the wall portion 7 into the positions shown in FIGS. 3 and 4—starting from the position in the comminuting mode—the wall portion 7 is respectively moved in the direction of rotation 17 of the comminuting rotor 5, in the illustrated view therefore in each case in the counter-clockwise direction about the respectively active axis of rotation 8 and 9 respectively.

The wall portion 7 forms about 80% of the rear wall of the material delivery space 6.

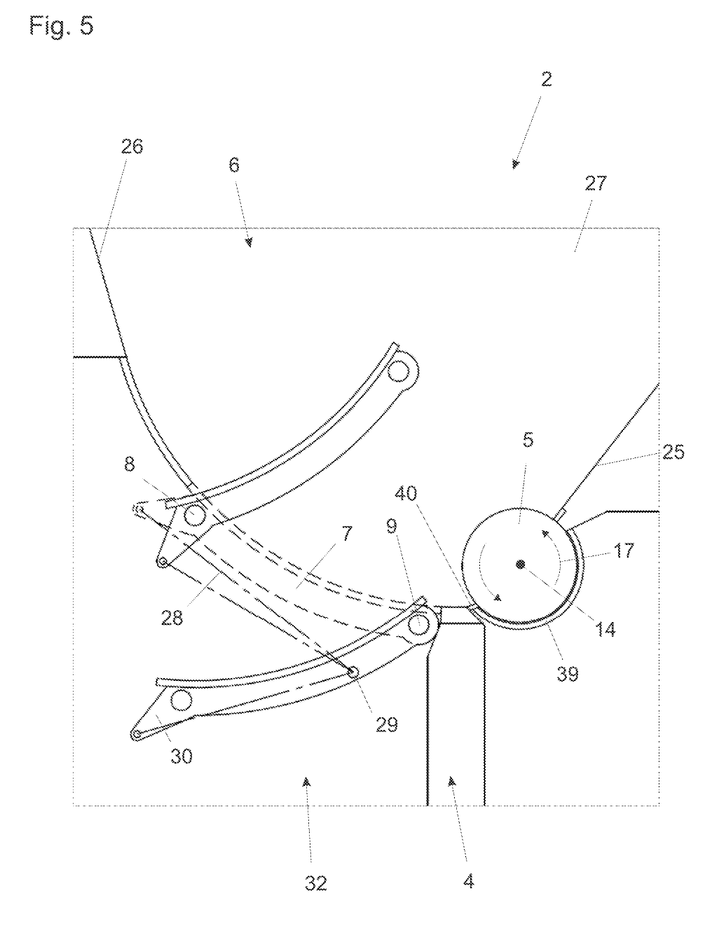

In comparison with the comminuting machine shown in FIGS. 2 to 4 the comminuting machine 2 shown in FIG. 5 does not have a feed device 20. More specifically the need for such a feed device 20 does not arise in all situations, in particular not when the material to be comminuted is a finely divided heavy material which slides in the direction of the comminuting rotor 5 in any case by virtue of the force of gravity.

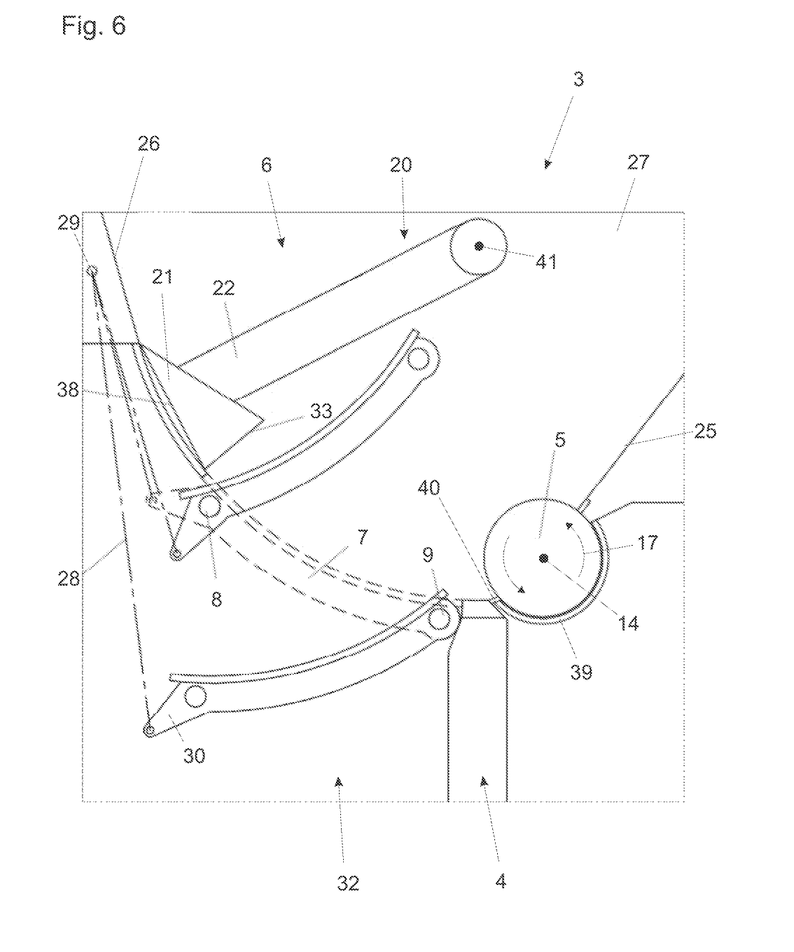

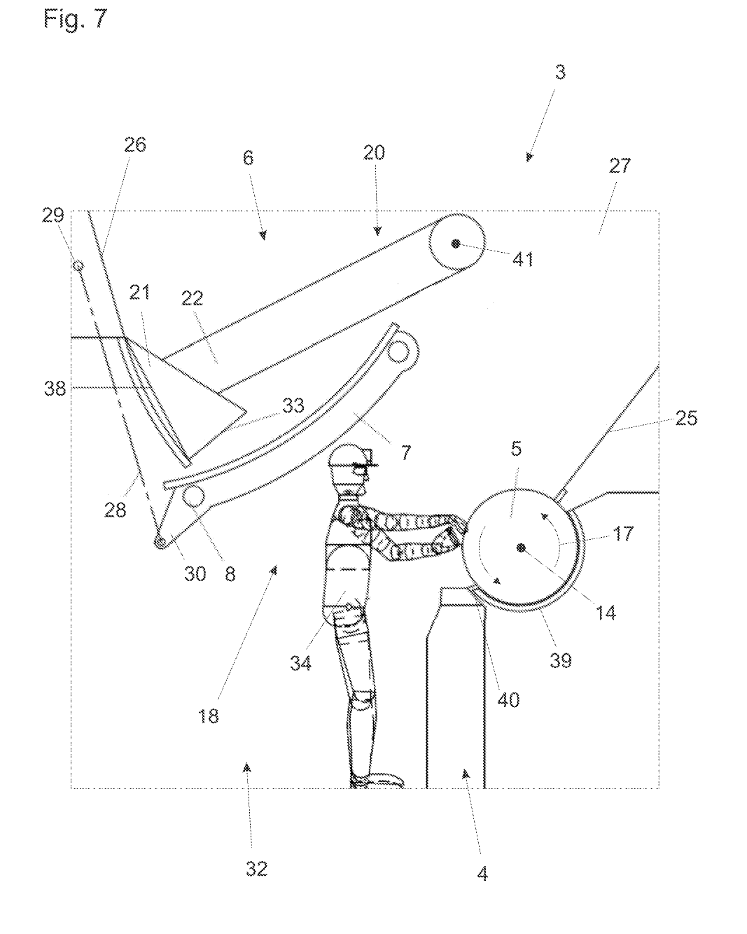

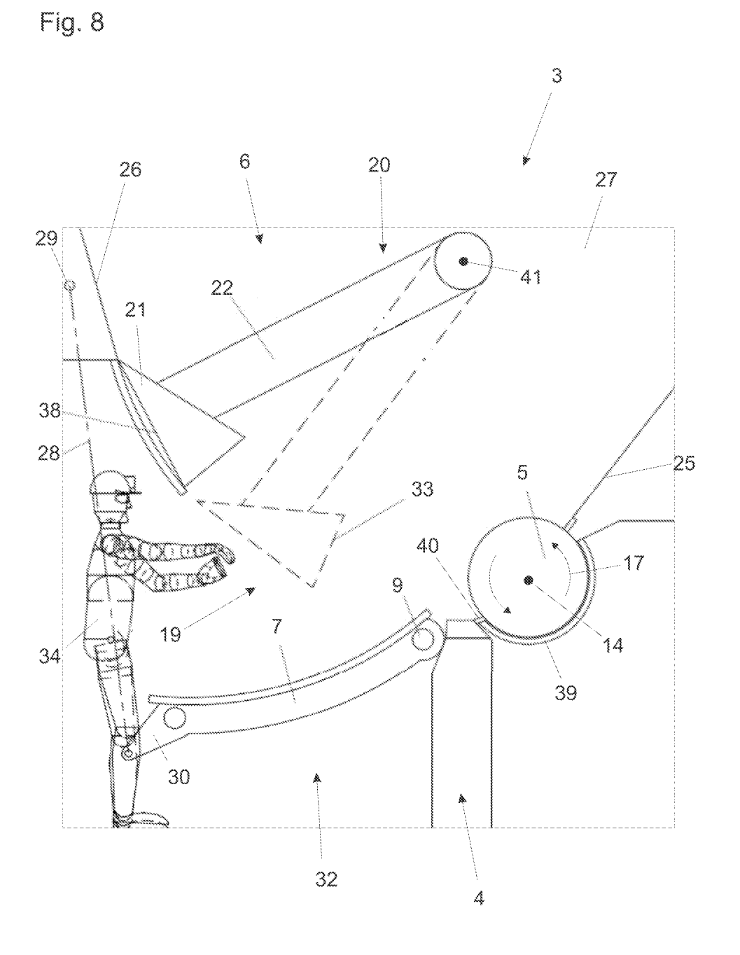

The comminuting apparatus 3 shown in FIGS. 6 to 8 differs from the comminuting apparatuses 1 and 2 shown in FIGS. 2 to 4 and FIG. 5 respectively in that in all positions of the wall portion 7 upon a pivotal movement about the first or second axis of rotation 8 or 9 respectively and in the mounted position of the comminuting machine 3 the displacement device 28 is arranged completely or for the predominant part not below but above the respectively active axis of rotation 8 or 9. Otherwise the view in FIG. 6 corresponds to the view in FIG. 2, the view in FIG. 7 corresponds to the view in FIG. 3 and the view in FIG. 8 corresponds to the view in FIG. 4.

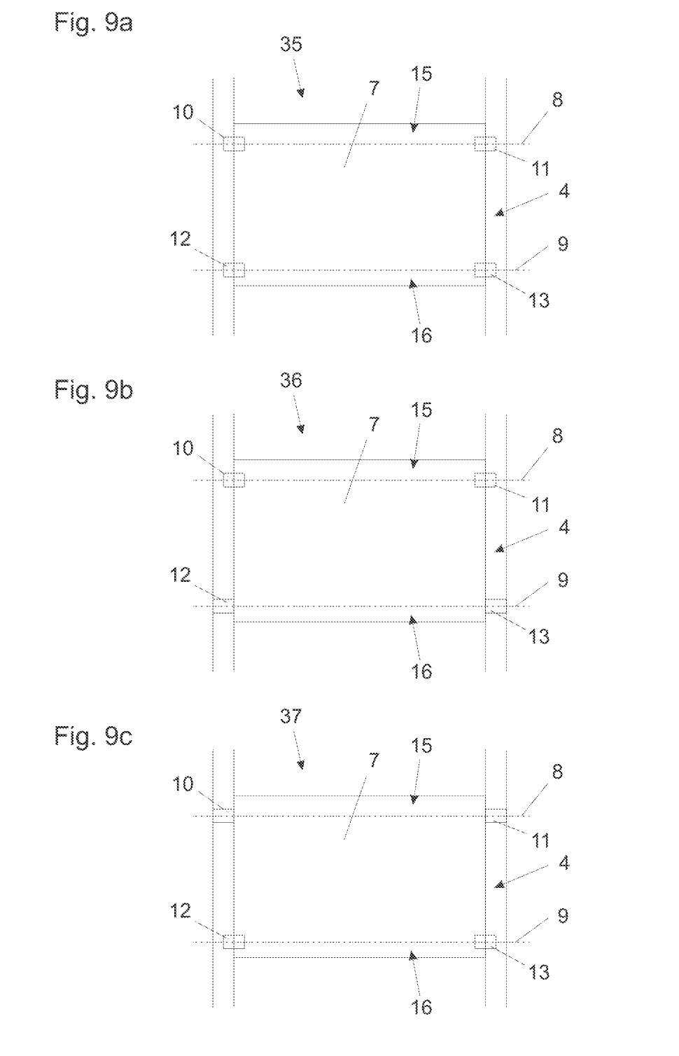

FIGS. 9a to 9c serve to illustrate on the one hand the comminuting mode 35 and on the other hand the maintenance mode 36 and 37 respectively.

The wall portion 7 is connected to the machine frame 4 by way of four releasably lockable mounting locations 10, 11, 12 and 13, wherein a first pair 10 and 11 of the four mounting locations define the first upper axis of rotation 8 and a second pair 12 and 13 of the four mounting locations define the second lower axis of rotation 9. All mounting locations 10, 11, 12 and 13 are locked in the comminuting mode 35, which means that the wall portion 7 is stationary.

In the maintenance mode 36 and 37 the wall portion 7 can now be pivoted on the one hand about the first axis of rotation 8 or on the other hand about the second axis of rotation 9. For that purpose the first axis of rotation 8 or the second axis of rotation 9 is locked and the non-active other axis of rotation 9 and 8 respectively is released.

The releasable locking action can be technically implemented by a mechanical, hydraulic or electrical locking means. For that purpose it is possible to provide at each of the four mounting locations 10, 11, 12 and 13 a bolt which is mounted to the machine frame 4 and which is displaceable between a position in which it engages into the wall portion 7 and a position in which it is not in engagement with the wall portion 7.

1. A comminuting machine for comminuting material, in particular recyclable materials, scrap wood and data carriers, comprising a machine frame, at least one comminuting rotor mounted rotatably to the machine frame and a material delivery space, wherein the material delivery space has at least one wall portion, by way of which the material to be comminuted can be fed to the at least one comminuting rotor, and which is stationary in a comminuting mode of operation of the comminuting machine and is pivotable about an axis of rotation in a maintenance mode of operation of the comminuting machine, characterised in that the axis of rotation is adapted to be releasably lockable, provided besides said first axis of rotation is at least one second releasably lockable axis of rotation and the at least one wall portion of the material delivery space in the maintenance mode of the comminuting machine is pivotable selectively about the first or the at least one second axis of rotation.

2. The comminuting machine according to claim 1, wherein the at least one wall portion is connected to the machine frame by way of four releasably lockable mounting locations and a first pair of the four mounting locations define the first axis of rotation and a second pair of the four mounting locations define the second axis of rotation.

3. The comminuting machine according to claim 1, wherein:
the two releasably lockable axes of rotation are oriented substantially parallel to each other and preferably substantially parallel to the axis of rotation of the at least one comminuting rotor, and/or
the first axis of rotation in the mounted position of the comminuting machine is arranged above the second axis of rotation, and/or
the first axis of rotation is arranged at a first end of the at least one wall portion and the second axis of rotation is arranged at a second end of the at least one wall portion, and/or
the second axis of rotation is arranged immediately adjacent to the at least one comminuting rotor.

4. The comminuting machine according to claim 1, wherein the at least one comminuting rotor has a given direction of rotation in the comminuting mode of the comminuting machine and the at least one wall portion of the material delivery space is moveable in the direction of rotation of the at least one comminuting rotor both upon a pivotal movement about the first axis of rotation and also upon a pivotal movement about the second axis of rotation—in each case starting from a position in the comminuting mode.

5. The comminuting machine according to claim 1, wherein upon a pivotal movement about the first axis of rotation starting from a position in the comminuting mode the at least one wall portion is moveable into the material delivery space and opens a first opening with access to the at least one comminuting rotor.

6. The comminuting machine according to claim 1, wherein upon a pivotal movement about the second axis of rotation starting from a position in the comminuting mode the at least one wall portion is moveable away from the material delivery space and opens a second opening.

7. The comminuting machine according to claim 1, wherein there is provided a feed device which is mounted pivotably to the machine frame and with which the material to be comminuted can be conveyed to the at least one comminuting rotor.

8. The comminuting machine according to claim 6, wherein upon a pivotal movement about the second axis of rotation the at least one wall portion opens an access to the feed device.

9. The comminuting machine according to claim 7, wherein the feed device includes a pressing member and at least one pivot arm having a first end and a second end, wherein the feed device is mounted to the machine frame by way of the first end of the at least one pivot arm and the pressing member is arranged at the second end of the at least one pivot arm.

10. The comminuting machine according to claim 9, wherein in the comminuting mode of the comminuting machine the pressing member of the feed device is moveable along the at least one wall portion.

11. The comminuting machine according to claim 1, wherein the material delivery space is defined at least by a front wall, a rear wall and two side walls and the at least one wall portion forms 60% to 90%, preferably 80%, of the rear wall.

12. The comminuting machine according to claim 1, wherein provided for the pivotal movement of the at least one wall portion of the material delivery space about the first or the second axis of rotation is at least one displacement device, preferably a piston-cylinder unit, which is supported on the one hand by way of at least one mounting location on the machine frame and which on the other hand is connected to the at least one wall portion by way of at least one engagement location, preferably an angled lever portion.

13. The comminuting machine according to claim 12, wherein the at least one displacement device performs a displacement movement directed in the same direction—with respect to the at least one mounting location—both for the pivotal movement of the at least one wall portion about the first axis of rotation and also for the pivotal movement of the at least one wall portion about the second axis of rotation—in each case starting from a position in the comminuting mode.

14. The comminuting machine according to claim 12, wherein the at least one displacement device in all positions of the at least one wall portion upon a pivotal movement about the first or second axis of rotation and in the mounted position of the comminuting machine is arranged completely or for the predominant part below or above the respectively active axis of rotation.

15. The comminuting machine according to claim 12, further comprising a housing which region-wise shields the comminuting machine outwardly and
the at least one displacement device is arranged at an inside of the housing, and/or
the at least one wall portion remains substantially completely within the housing both upon a pivotal movement about the first axis of rotation and also upon a pivotal movement about the second axis of rotation.
